(19) United States
(12) Patent Application Publication
(10) Pub. No.: US 2015/0187236 A1
(43) Pub. Date: Jul. 2, 2015

(54) POST TOPPER

(71) Applicant: Gregg L. Beckley, Benge, WA (US)

(72) Inventor: Gregg L. Beckley, Benge, WA (US)

(21) Appl. No.: 14/586,935

(22) Filed: Dec. 30, 2014

Related U.S. Application Data
(60) Provisional application No. 61/922,637, filed on Dec. 31, 2013.

(51) Int. Cl. G09F 7/18; E04H 17/00

(52) U.S. Cl. CPC G09F 7/18; E04H 17/00; E04H 2017/006; G09F 2007/1804

(57) ABSTRACT

A post topper is provided. A post topper consists of a slotted tubular hardware member that can be placed over a fence post and fence wire in to display a message, indicator, or sign without having to dig a hole or place an anchor to support the sign. The post topper needs no additional attachment hardware or tools to be placed permanently on a fence. The post topper may convey an alphanumeric message or may be used as an indicator, with color coding, for landmarks, targets, openings, gates, paths, roads, wires, pipes, fiber optics, culverts, etc., or may constitute levels of warning, such as fire danger, speed limits, snow depth, relative hunting or no hunting areas, and so forth. The markers may be used in games or events, such as running races, motorized vehicles races, paintball events, shooting events, rodeos, dog trials, equestrian events, county fairs, carnivals, and the like.

### BACKGROUND

A fence protecting a large tract of land or running along a highway may be extensive, even miles long. Signage for protecting the fence line can be too expensive or too labor intensive to post at numerous regular intervals. Thus, it can be difficult to relay information to those passing by or to give proper notice to trespassers along a long fence line. In the case of posting no trespassing messages, for example, the signs may need to be posted at intervals sufficient that an observer anywhere along the fence line will be put on notice. Conventional standalone flat signs are unwieldy and vulnerable to wind and weather, and also need posts, fasteners, and anchoring, which greatly increases their expense and the labor of installing such signs.

### SUMMARY

A post topper is provided. A post topper consists of a slotted hollow tubular member that can be placed over a fence post and fence wire in to display a message, indicator, or sign without having to dig a hole or place an anchor to support the sign. The post topper needs no additional attachment hardware or tools to be placed permanently on a fence. The post topper may convey an alphanumeric message or may be used as an indicator, with color coding, for landmarks, targets, openings, gates, paths, roads, wires, pipes, fiber optics, culverts, etc., or may constitute levels of warning, such as fire danger, speed limits, snow depth, relative hunting or no hunting areas, and so forth. The markers may be used in games or events, such as running races, motorized vehicles races, paintball events, shooting events, rodeos, dog trials, equestrian events, county fairs, carnivals, and the like.

This summary section is not intended to give a full description of the subject matter, or to provide a list of features and elements. A detailed description of example embodiments of the post topper follows.

### BRIEF DESCRIPTION OF THE DRAWINGS

FIG. 1 is a diagram of example tubular members for making a post topper.

FIG. 2 is a diagram showing placement of a post topper on a fence.

FIG. 3 is a diagram showing a post topper in place on a fence and displaying a message.

FIG. 4 is a diagram showing multiple post toppers in place at intervals on a fence.

FIG. 5 is a diagram showing an implementation of an example post topper suited to anchor a conventional sign on a fence.

FIG. 6 is a diagram showing an implementation of an example post topper attachable to wires only without requiring a fence post.

FIG. 7 is a diagram showing an implementation of an example post topper suitable for placing over a conventional sign as a temporary or emergency marker.

### DETAILED DESCRIPTION

This disclosure describes post topper devices. A post topper is a hollow tubular member that can be placed on or over a fence post or fence part in order to display a sign, indicator, warning, or message on or above the fence or the fence post, without having to dig a hole in the ground or place an anchor on the ground or in the ground to support the sign. The post topper needs no additional attachment hardware or tools to be placed permanently on a fence. Implementations of the post topper may be placed over a fence post and its attached wires or planks or, in one implementation, a post topper may be place over the wires only or the planks only without needing a fence post. The post topper can be made of inexpensive materials so that numerous instances can be made and placed over numerous fence posts of a fence surrounding a large tract of land.

A barb wire fence has posts meant to support a span of wire but is not suited to easily support the expanse or the weight of most conventional signs. A barb wire fence usually lacks wooden posts or metal posts of a size or sturdiness sufficient to support conventional signage of appreciable size.

In an implementation, an example post topper includes a pipe or other tubular member (the term “tubular member” as used herein represents tubes and pipes of various sizes and compositions) that has been slotted along a partial axial length of the pipe. The pipe itself can be sized with an inside diameter selected to fit easily over an outside diameter (OD) or outside circumference of a particular style of fence post in use around a given parcel of land or running along a line. Slots along an axial direction of the pipe allow the post topper to be placed over barbed wire that may be strung between fence posts being topped with the post topper. Depending on implementation, the slots may also allow the post topper to be placed over fence planking, instead of barbed wire.

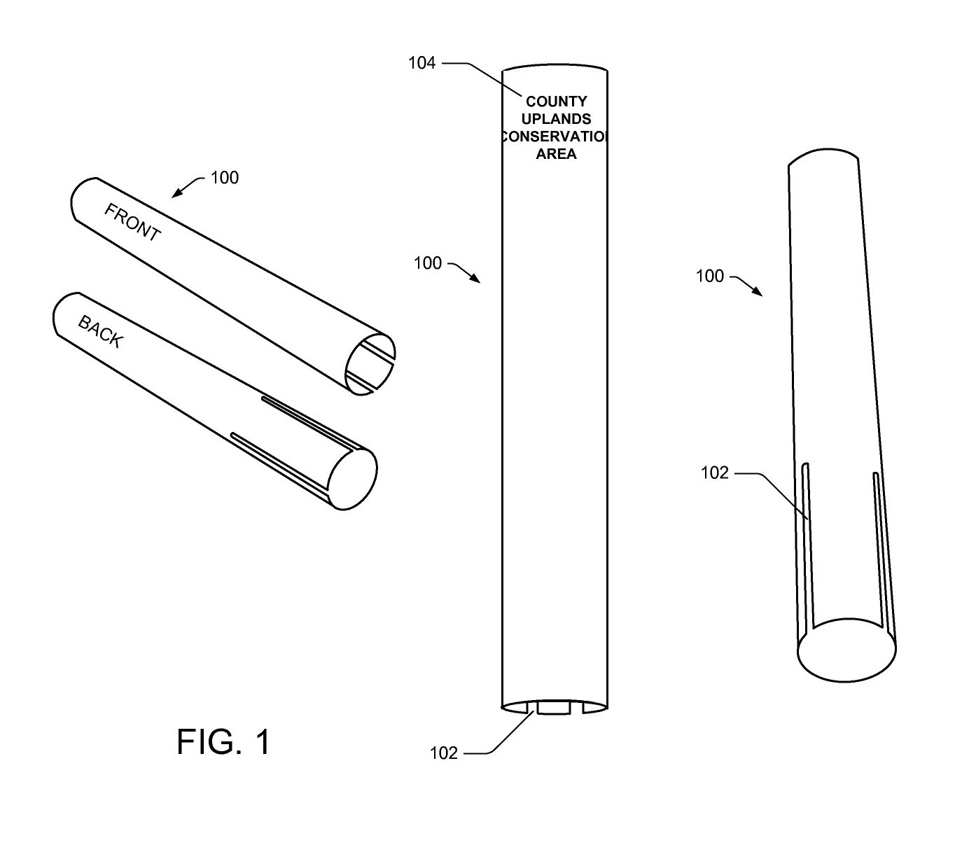

FIG. 1 shows an example post topper consisting of a tubular member 100. The tubular member 100 is sized to fit over a fence post and may have multiple slots 102, such as two slots 102, for fitting over fence wire or other fencing material attached to the fence post being topped.

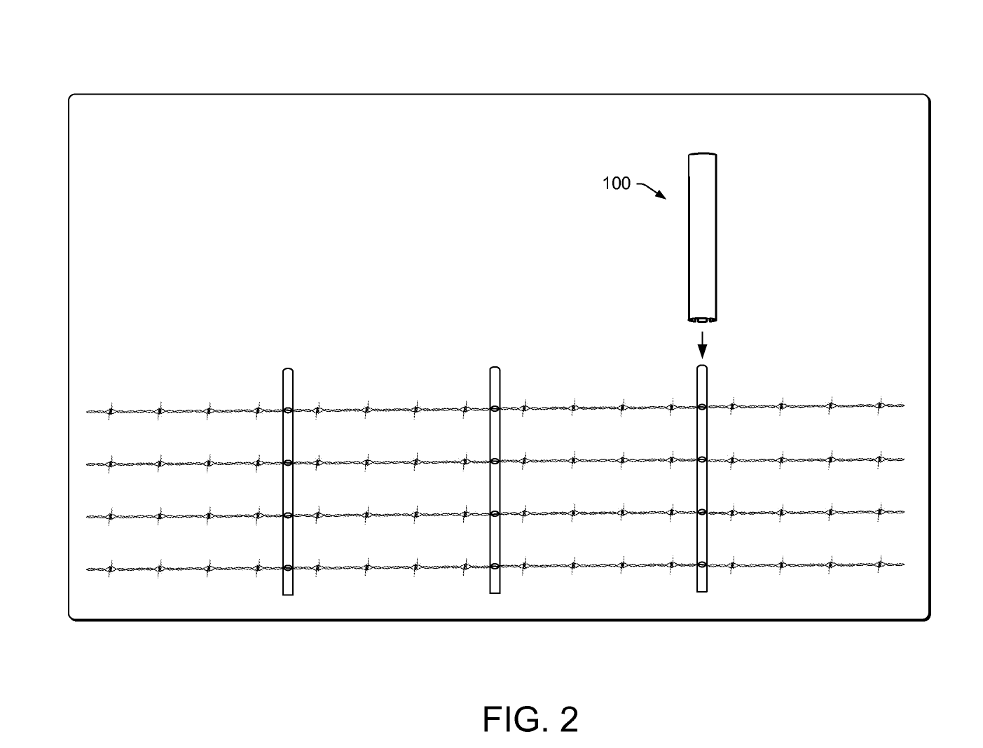

FIG. 2 shows placement of an example post topper over a fence post and over the wire attached to the fence post. The slots 102 in the post topper allow the tubular member 100 to be place further down on the fence post than would be allowed without the slots 102. The fence wire or planking surmounted by the slots 102 provide extra stability to the tubular member 100, and especially secure the tubular member 100, and its message 104, from rotating on the fence post.

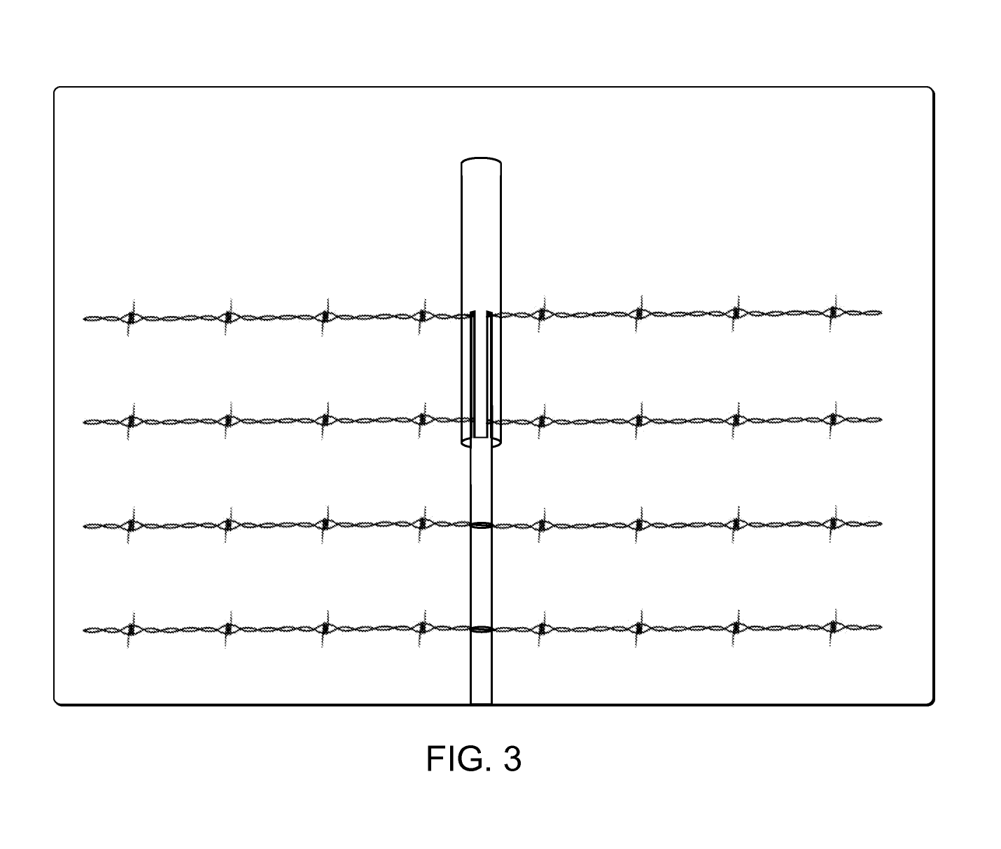

FIG. 3 shows an example post topper placed on a fence. Once in place, the post topper displays a message 104, or even without an alphanumeric message 104, provides a message 104 by being a marker or an indicator in itself, by its visible placement and presence on a fence. The message 104, therefore, may be human readable and/or may also be a simple color coding of the particular instance of the post topper. The message 104 consisting of a color code or a coloration may indicate degrees of proximity to landmarks, targets, openings, gates, paths, roads, wires, pipes, fiber optics, culverts, etc., or may constitute levels of warning, such as fire danger, speed limits, snow depth, relative hunting or no hunting areas, and so forth. The markers may be used in games or events, such as running races, motorized vehicles races, paintball events, shooting events, rodeos, dog trials, equestrian events, county fairs, carnivals, and the like.

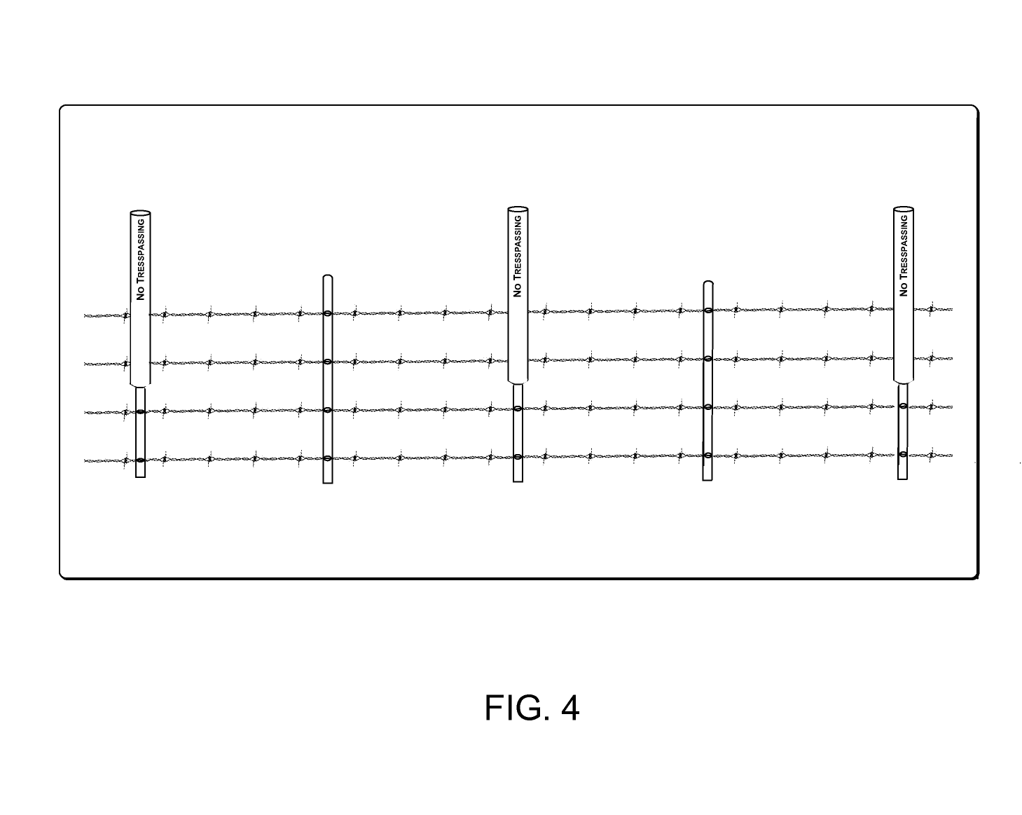

FIG. 4 shows instances of an example post topper placed at intervals along a fence. The post topper may also be used at intervals on fences or on posts along roads, highways, and freeways, as highway indicators.

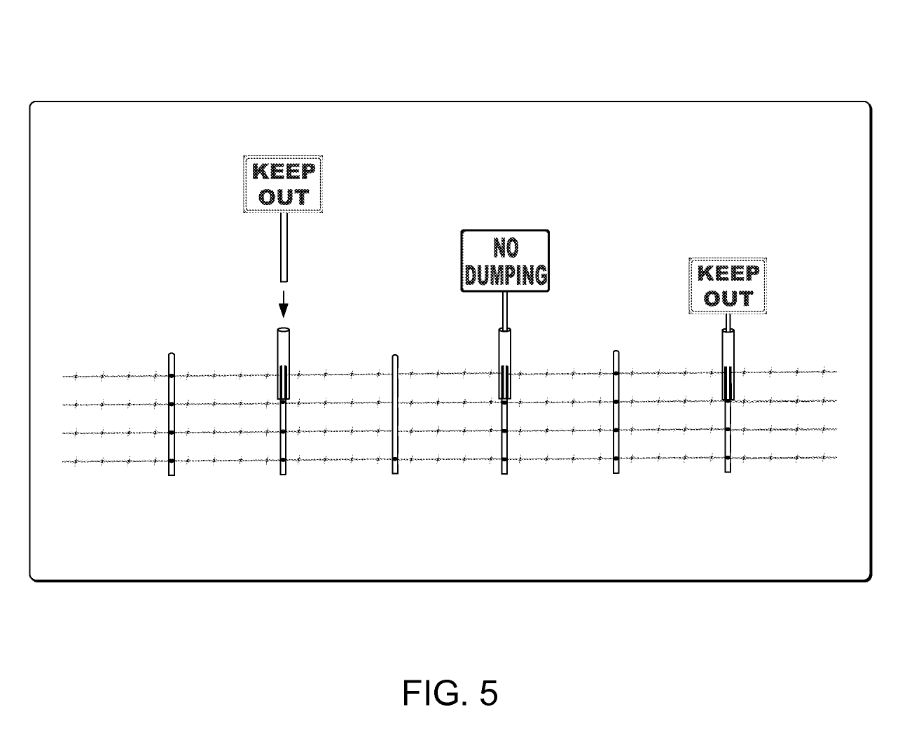

FIG. 5 shows an alternative implementation, in which example post toppers are placed on a fence and may optionally anchor conventional signs.

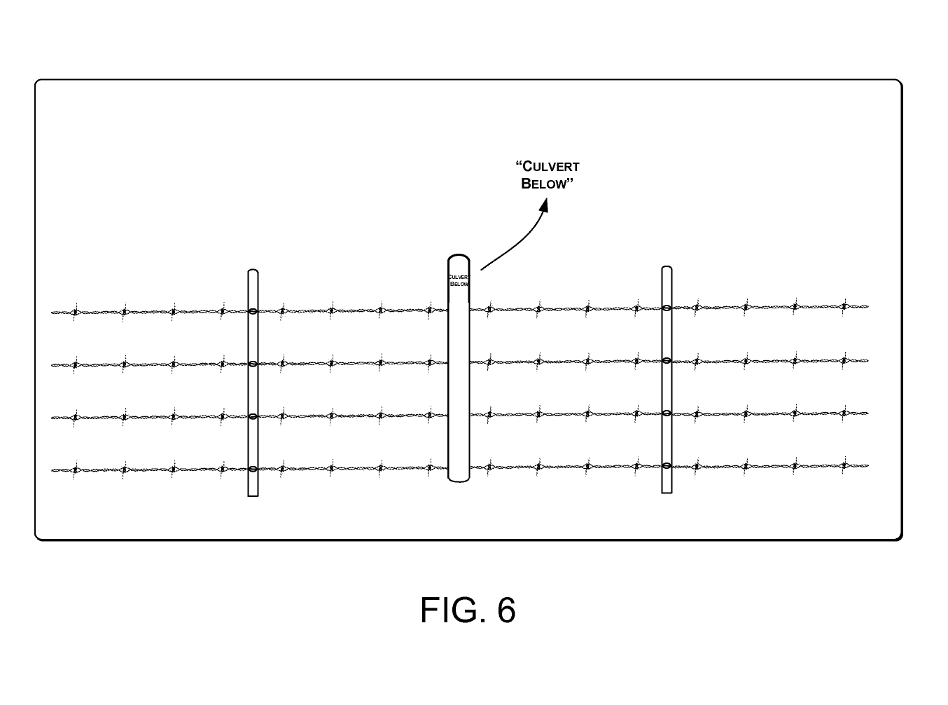

FIG. 6 shows an implementation, in which an example post topper has slots 102 placed in order to fit over fence wire (or planking) at a location that does not have a fence post. This implementation can be used for marking specific locations (e.g., hidden culvert, buried wire, surveying marker) along a fence line, where there is no fence post available at the specific location that needs to be marked.

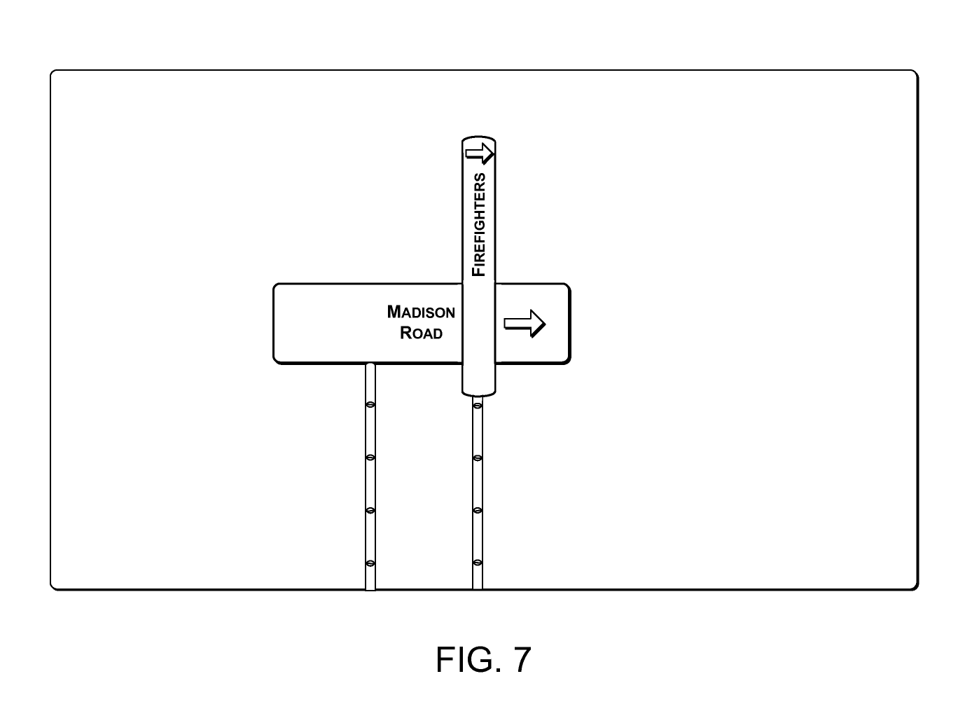

FIG. 7 shows an example post topper constructed to fit over conventional signs, preferably as a temporary or emergency marker.

### CONCLUSION

Although exemplary systems and methods have been described in language specific to structural features or techniques, the subject matter defined in the appended claims is not necessarily limited to the specific features or acts described. Rather, the specific features and acts are disclosed as example forms of implementing the claimed systems, methods, and structures.

1. A post topper, comprising:
a tubular member to fit over a fence post or fence wire;
slots along an axial direction of the tubular member for fitting the post topper over at least one strand of wire or at least one span of fence planking; and
an outer surface of the tubular member suitable for displaying a message.

2. The post topper of claim 1, wherein the tubular member comprises a polycarbonate plastic.

3. The post topper of claim 1, wherein the tubular member comprises a metal.

4. The post topper of claim 1, wherein the slots placed over at least one strand of wire or at least one span of fence planking secure the tubular member from rotating on the fence post.

5. The post topper of claim 1, further comprising a fastener on an outer surface of the tubular member for securing a conventional sign.

6. The post topper of claim 1, further comprising a visible message on an outer surface of the tubular member.

7. The post topper of claim 1, further comprising a visible message on an outer surface of the tubular member, wherein the visible message comprises a color code or a coloration.

8. The post topper of claim 1, wherein the tubular member is constructed to hold a post of a conventional sign to a fence or a fence post.

9. The post topper of claim 1, wherein the tubular member is constructed to fit over a conventional sign post and over a conventional sign attached to the conventional sign post, as a temporary or an emergency marker.

10. The post topper of claim 1, wherein the tubular member has one of a square, round, triangular, or polygonal cross-section.

11. A post topper, comprising:
a tubular member to fit over a fence wire;
slots along an axial direction of the tubular member for fitting the post topper over the fence wire at a location where there is no fence post; and
an outer surface of the tubular member suitable for displaying a message.

12. A method, comprising:
determining a diameter of a fence post;
constructing a pipe to fit over the fence post;
creating slots in the pipe to allow the pipe to fit over the fence post and over one or more wires connected to the fence post.
